(19) United States
(12) Patent Application Publication
(10) Pub. No.: US 2024/0102704 A1
(43) Pub. Date: Mar. 28, 2024

(54) HEAT PUMP

(71) Applicant: VIESSMANN CLIMATE SOLUTIONS SE, Allendorf (DE)

(72) Inventors: Thorsten SCHMIDT, Marburg (DE); Eduard LANG, Allendorf (DE); Markus IMMEL, Gladenbach (DE); Philipp NÖH, Breitscheid (DE)

(73) Assignee: VIESSMANN CLIMATE SOLUTIONS SE, Allendorf (DE)

(21) Appl. No.: 18/276,494

(22) PCT Filed: Feb. 3, 2022
(86) PCT No.: PCT/DE2022/100094

§ 371 Date: Aug. 9, 2023

(30) Foreign Application Priority Data
Feb. 10, 2021 (DE) 10 2021 103 059.5

(51) Int. Cl. F25B 30/02

(52) U.S. Cl. CPC F25B 30/02; F25B 2500/13

(57) ABSTRACT

A heat pump includes a housing, at least one load transfer element arranged on an underside of the housing, a compressor arranged in the housing perpendicularly above the load transfer element, and further heat pump components that are likewise arranged in the housing, wherein a resilient insulating element is arranged between the compressor and the load transfer element. A plurality of heat pump components are positioned on a common carrying element arranged perpendicularly above a load transfer element, wherein a resilient insulating element is arranged between the carrying element and the load transfer element, wherein the compressor and the carrying element are assigned to the same load transfer element.

The invention relates to a heat pump according to the preamble of patent claim 1.

A heat pump of the above-mentioned type is produced and sold, for example, by the applicant under the product name VITOCAL 222-A. This heat pump consists of a housing, at least one load transfer element (in this case a bottom track) arranged on an underside of the housing, a compressor arranged in the housing perpendicularly above the load transfer element, and further heat pump components, which are likewise arranged in the housing, wherein a resilient insulating element is arranged between the compressor and the load transfer element.

The invention is based on the object of further improving a heat pump of the above-mentioned type. In particular, an even quieter heat pump is to be created.

This object is solved with a heat pump of the above-mentioned type by means of the features listed in the characterizing part of patent claim 1.

According to the invention, it is thus provided that several heat pump components are positioned on a common carrying element arranged perpendicularly above a load transfer element, wherein a resilient insulating element is arranged between the carrying element and the load transfer element, wherein the compressor and the carrying element are assigned to the same load transfer element.

In other words, the solution according to the invention is characterized in that possible vibrations originating at the compressor and the further heat pump components are prevented from propagating. Due to this systematic arrangement and the structural design of the load transfer element, a rigid body behavior in the low-frequency range up to at least 100 Hz is thus basically attained for the compressor, the heat pump components, and the load-transferring structure.

Other advantageous further developments follow from the dependent patent claims.

For the sake of completeness, reference is also made to the following documents:

A device of a similar species is known from the document US 2021/0018189 A1, but which differs from the solution according to the invention at least in that the compressor as well as the carrying element comprising the heat pump components are not arranged there perpendicularly above a load transfer element.

Moreover, at least the same applies for the devices according to the documents GB 2483446 A, CN 207662015 U, and EP 3 789 696 A1.

The heat pump according to the invention, including its advantageous further developments according to the dependent patent claims will be described in more detail below on the basis of the graphic illustration of different exemplary embodiments.

Schematically,

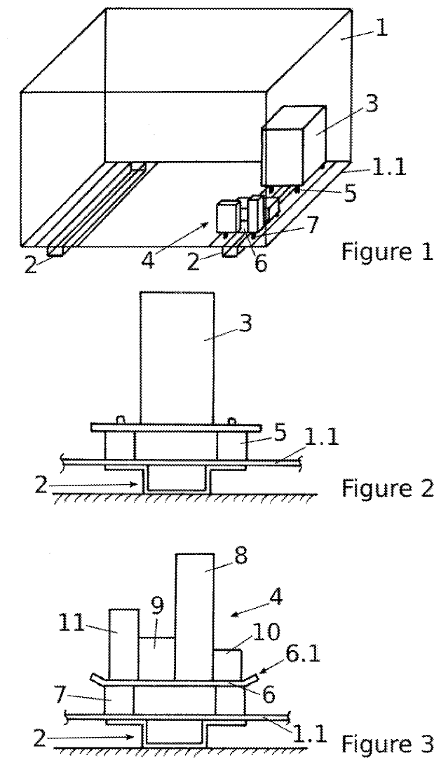

FIG. 1 shows the heat pump according to the invention comprising the carrying element for the heat pump components in perspective view;

FIG. 2 shows the compressor positioned on the load transfer element in side view;

FIG. 3 shows the carrying element positioned on the load transfer element comprising the heat pump components in side view;

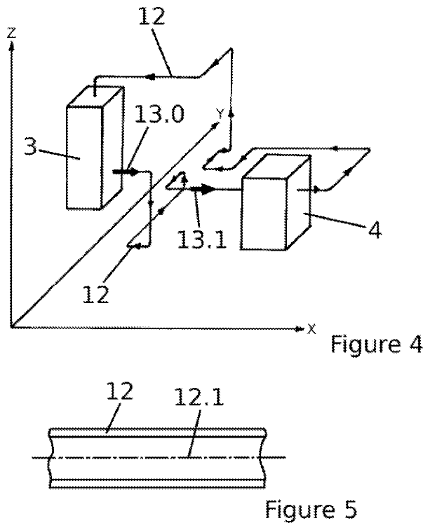

FIG. 4 shows a heat pump comprising a fluid line wound in all directions between the compressor and the heat pump component in a schematic manner; and

FIG. 5 shows a section through the fluid line according to FIG. 4.

The heat pump illustrated in the figures consists of a housing 1, at least one load transfer element 2 arranged on an underside 1.1 of the housing 1, a compressor 3 arranged in the housing 1 perpendicularly above the load transfer element 2, and further heat pump components 4, which are likewise arranged in the housing 1, wherein a resilient insulating element 5 is arranged between the compressor 3 and the load transfer element 2.

It is now essential for the heat pump according to the invention that several heat pump components 4 are positioned on a common carrying element 6 arranged perpendicularly above a load transfer element 2, wherein a resilient insulating element 7 is arranged between the carrying element 6 and the load transfer element 2, wherein the compressor 3 and the carrying element 6 are assigned to the same load transfer element 2.

The above-used wording “several heat pump components” thereby comprises all possible components of a heat pump, except for the above-mentioned compressor 3, from which it follows, conversely, that the carrying element 6 is formed in a compressor-free manner, thus that the compressor 3 is not arranged on the carrying element 6 in the case of the solution according to the invention (and as can be seen from the figures).

The above-used requirement “perpendicularly above” thereby means in particular that the compressor 3 as well as the carrying element 6 (comprising the further heat pump components 4) is in each case arranged with its center of gravity perpendicularly above the load transfer element 2.

It is preferred thereby that the underside 1.1 of the housing 1 is made of a sheet metal (also referred to as a bottom plate) arranged between the load transfer element 2 and the resilient insulating element 5, 7, see FIGS. 2 and 3. It is furthermore preferred that the resilient insulating element 5, 7 is at least partially made of an elastomer, preferably of polyurethane foam. It is additionally preferred that the compressor 3 is formed to be connected to the load transfer element 2 via at least three resilient insulating elements 5 (which are preferably arranged on the corners of an imaginary triangle).

It is furthermore preferred that two load transfer elements 2 are arranged on the underside 1.1 of the housing 1, preferably parallel to one another. The load transfer element 2 is likewise preferably formed to be at least three times, preferably six times, particularly preferably eight times longer than wide or high, respectively, and/or the load transfer element 2 is preferably formed as profile rail made of sheet metal.

It is additionally preferred that a heat exchanger 8, preferably a plate heat exchanger, an expansion means 9, a valve means 10 and/or a coolant accumulator 11 are or is optionally arranged, respectively, on the carrying element 6 as heat pump components 4, see FIG. 3. It is likewise preferred that the carrying element 6 is formed in a plate-shaped manner, preferably of sheet metal. The plate-shaped carrying element 6 is thereby formed so as to be provided with chamfers 6.1 on the edge side. This serves the purpose of reinforcing the carrying element 6 and promotes the rigid body vibration behavior of the heat pump. It is furthermore preferred that the heat pump components 4 are arranged so as to be fastened to the carrying element 6. The carrying element 6 is further preferably and except for the contact via the bases resulting from the arrangement above the load transfer element 2 moreover formed so as to be connected in a fixation-free manner to the load transfer element 2. This passive block thus ultimately simply stands on the load transfer element 2, wherein a lateral displacement is ruled out in particular simply due to the piping to the compressor 3.

In its above-described embodiments, the heat pump according to the invention has a rigid body behavior, which leads to a good insulation of the low-frequency vibrations generated by the heat pump components 4 and in particular the compressor 3. The noise exposure is significantly reduced thereby by means of the heat pump.

What is furthermore preferably provided:

The heat pump illustrated schematically in FIG. 4 preferably consists of the compressor 3, which is formed to be connected via two coolant-conveying fluid lines 12 to one of the heat pump components 4, through which coolant flows, wherein each fluid line 12 has a longitudinal axis 12.1 (see FIG. 5 with regard to this), wherein an imaginary direction vector 13.1, which coincides with the longitudinal axis 12.1, in the course between the compressor 3 and the heat pump component 4, points at least once in a different direction than an imaginary initial direction vector 13.0, which starts at the compressor 3 and likewise coincides there with the longitudinal axis 12.1, wherein the longitudinal axis 12.1 is formed so as run in a space with three imaginary planes XY, XZ, YZ, which are perpendicular to one another.

In order to suppress a vibration transmission from the compressor 3, which preferably comprises an electric motor, to the at least one heat pump component 4 as much as possible, it is now preferably provided that the fluid line 12 is shaped so that in the course between the compressor 3 and the heat pump component 4 and with regard to all three planes XY, XZ, YZ, the direction vector 13.1 is formed so as to run being rotated at least once about an angle of 180° to the initial direction vector 13.0.

As a whole, this requirement leads to an increase of the resilience or decrease of the stiffness, respectively, of the fluid line between the compressor 3 and the heat pump component 4 and thus to a reduced vibration transmission.

This solution according to FIG. 4 thereby ultimately assumes that the fluid line 12 is preferably made of a metallic material. If applicable, plastic can preferably also be considered. However, the more resilient the actually used material of the fluid line per se, the less it logically requires the approach according to FIG. 4.

In order to realize a flow of the coolant, which is as undisturbed as possible, through the fluid line 12, it is further preferably provided that said fluid line is formed to be continuously curved on all of its curved regions. The term “continuously” is meant mathematically thereby. In other words, it is to thus be provided that the fluid line 12 does not have any sharp-edged bends. The changes in direction of the fluid line 12 are therefore illustrated in a rounded manner in FIG. 4.

It is furthermore preferably provided that in the course between the compressor 3 and the heat pump component 4, the fluid line 12 is formed so as to be at least partially conveyed optionally around the compressor 3 and/or the heat pump component 4. This requirement, which further contributes to the reduction of a vibration transmission, applies for the fluid line 12, which leads from the heat pump component 4 to the compressor 3 (as clarified by the corresponding arrows).

It is additionally further particularly preferably provided that the deflection of the fluid line 12 does not only take place by at least 180°, but preferably by at least 270°. More preferably, it is provided that the fluid line 12 is shaped so that in the course between the compressor 3 and the heat pump component 4 and with regard to one of the three planes XY, XZ, YZ, the direction vector 13.1 is formed to perform a complete 360° turn compared to the initial direction vector 13.0. In FIG. 4, both illustrated fluid lines 12 fulfill exactly this requirement.

The heat pump according to the invention furthermore preferably consists of the compressor 3 for compressing a coolant and the heat pump components 4, through which the coolant flows, wherein the compressor 3 is formed to be connected to one of the further heat pump components 4 in order to convey the coolant over fluid lines 12, and wherein the compressor 3 and the further heat pump component 4 are formed so as to be connected to a housing 1 of the heat pump via spring elements in order to reduce a transmission of structure-borne sound.

It is thereby preferably provided that the spring elements are (in fact) at least partially made of an elastomer, in particular polyurethane foam, thus as resilient insulating elements 5, 7.

It is further preferably provided that a first fluid line 12 is formed as coolant supply line to the compressor 3, and a second fluid line 12 as coolant discharge line from the compressor 3.

It is furthermore preferably provided that the fluid lines 12 are optionally made of a material with a stiffness, such as a metallic material and/or of a metallic material.

It is advantageously furthermore provided that, on the one hand, the compressor 3 and the further heat pump component 4 are formed so as to be firmly connected via the fluid lines 12 connecting them, and, on the other hand, via the resilient insulating elements 5, 7, which are connected to the housing 1 of the heat pump. This requirement leads to a particularly good decoupling of the compressor 3 from the other heat pump components 4 and thus to a very low-noise heat pump.

Examined even more closely, it is particularly preferably provided that the further heat pump component 4 is formed as valve means, in particular as multi-way valve.

As already mentioned above, it is furthermore provided that the further heat pump component 4 is positioned on the carrying element 6. It is thereby furthermore preferably provided that the carrying element 6 is formed to be connected to the housing 1 of the heat pump via the spring elements. It is further also preferably provided that further heat pump components 4 of the heat pump, such as a heat exchanger 8, an expansion means 9 and/or a coolant accumulator 11, are positioned on the carrying element 6. These further, passive heat pump components (because they do not produce vibrations themselves) thereby advantageously form an integrated assembly on the carrying element 6, as can be seen, which is ultimately stimulated to vibrate only via the fluid lines 12.

The heat pump according to the invention furthermore preferably consists of a compressor 3, which operates within an operational speed range and which thereby causes at least an interference frequency of the first order, for compressing a coolant and further heat pump components 4, which are arranged on the carrying element 6 and through which the coolant likewise flows.

Examined more closely, it is preferably provided here that at least one heat exchanger 8, a valve means 10 and/or an expansion means 9 are optionally arranged on the carrying element 6.

It is furthermore preferably provided that a unit consisting of the carrying element 6 and the heat pump components 4 arranged thereon has a first natural frequency, which is greater than the interference frequency of the first order, which is transmitted by the compressor 3 operating in the operational speed range to the unit acting in a rigid body-like manner.

It is thereby particularly preferably provided that the compressor 3 has an operational speed range from 700 to 7200 revolutions per minute, particularly preferably from 800 to 6900 revolutions per minute, more preferably from 900 to 6600 revolutions per minute.

It is additionally particularly preferably provided that the unit consisting of the carrying element 6 and the heat pump components 4 arranged thereon has a first natural frequency of more than 100 Hz, particularly preferably of more than 120 Hz, most preferably of more than 140 Hz.

In order to work towards the above-mentioned condition, it is furthermore particularly preferably provided that the carrying element 6 (already!) has a first natural frequency, which is greater than the interference frequency of the first order caused by the compressor 3 operating in the operational speed range.

In order to work even further towards the above-mentioned condition, it is furthermore particularly preferably provided that each heat pump component 4 has a first natural frequency, which is greater than the interference frequency of the first order, which is caused by the compressor 3 operating in the operational speed range.

In the event that due to a corresponding material selection of a piping of the heat pump components 4, there is likewise a need to act, it is furthermore particularly preferably provided that the unit, including the piping of the heat pump components 4, has a first natural frequency, which is greater than the interference frequency of the first order, which is transmitted by the compressor 3 operating in the operational speed range to the unit, which acts in a rigid body-like manner.

In other words, it is thus preferably provided that a coupled natural frequency of the entire unit is basically determined on the basis of the local natural frequencies of the individual components or is designed so that it lies above the interference frequency of the first order of the compressor 3, respectively.

In order to increase the local natural frequency, as illustrated in FIG. 3, it is thus also provided, for example, that the carrying element 6 is formed as plate comprising a chamfer in order to increase its natural frequency. It can furthermore preferably be provided that the carrying element 6 is formed to be thicker than is required for the actual load.

It is furthermore preferably provided that the compressor 3 is formed to be fastened to a housing 1 of the heat pump via a (typically—and as illustrated—several) resilient insulating element(s) 5. In a similar way, it is further preferably provided that the carrying element 6 is formed to be fastened to a housing 1 of the heat pump via one (or several) resilient insulating element(s) 7.

It is thereby furthermore particularly preferably provided that the resilient insulating element 5, 7 is at least partially made of an elastomer, preferably of polyurethane foam.

It is furthermore preferably provided that the compressor 3 and the unit, except for required fluid lines 12 between the compressor 3 and the unit, are formed to be able to vibrate independently of one another.

In order to ensure an even load on the insulating element 7 (or on the insulating elements 7, respectively), it is lastly particularly preferably provided that a center of gravity of the unit—due to suitable arrangement of the heat pump components 4—is selected so that a perpendicular introduction of gravitational force into the insulating element 7 (or into the insulating elements 7, respectively) results. This requirement applies analogously for the compressor 3 and its insulating element 5 (or its insulating elements 5, respectively).

### LIST OF REFERENCE NUMERALS

1 housing
1.1 underside
2 load transfer element
3 compressor
4 heat pump component
5 resilient insulating element
6 carrying element
6.1 chamfer
7 resilient insulating element
8 heat exchanger
9 expansion means
10 valve means
11 coolant accumulator
12 fluid line
12.1 longitudinal axis
13.0 initial direction vector
13.1 direction vector
XY plane, perpendicularly to XZ and YZ
XZ plane, perpendicularly to XY and YZ
YZ plane, perpendicularly to XY and XZ

1. A heat pump, comprising a housing (1), at least one load transfer element (2) arranged on an underside (1.1) of the housing (1), a compressor (3) arranged in the housing (1) perpendicularly above the load transfer element (2), and further heat pump components (4), which are likewise arranged in the housing (1), wherein a resilient insulating element (5) is arranged between the compressor (3) and the load transfer element (2),
wherein several heat pump components (4) are positioned on a common carrying element (6) arranged perpendicularly above a load transfer element (2), wherein a resilient insulating element (7) is arranged between the carrying element (6) and the load transfer element (2), wherein the compressor (3) and the carrying element (6) are assigned to the same load transfer element (2) and wherein the carrying element (6) is formed in a compressor-free manner.

2. The heat pump according to claim 1,
wherein a heat exchanger (8), an expansion means (9), a valve means (10) and/or a coolant accumulator (11) are or is optionally arranged, respectively, on the carrying element (6).

3. The heat pump according to claim 1,
wherein the carrying element (6) is formed in a plate-shaped manner.

4. The heat pump according to claim 3,
wherein the plate-shaped carrying element (6) is formed to be provided with chamfers (6.1) on the edge side.

5. The heat pump according to claim 1,
wherein the heat pump components (4) are arranged so as to be fastened to the carrying element (6).

6. The heat pump according to claim 1,
wherein except for the contact via the bases resulting from the arrangement above the load transfer element (2), the carrying element (6) is moreover formed so as to be connected in a fixation-free manner to the load transfer element (2).

7. The heat pump according to claim 1,
wherein the underside (1.1) of the housing (1) is made of a sheet metal arranged between the load transfer element (2) and the resilient insulating element (5, 7).

8. The heat pump according to claim 1,
wherein the load transfer element (2) is formed as profile rail made of sheet metal.

9. The heat pump according to claim 1,
wherein the elastic insulating element (5, 7) is at least partially made of an elastomer.
